(19) United States
(12) Patent Application Publication
(10) Pub. No.: US 2016/0078423 A1
(43) Pub. Date: Mar. 17, 2016

(54) SYSTEM AND METHOD FOR POINT OF SALE PRODUCT SOFTWARE ENHANCEMENT

(71) Applicants: Mathew Smith, Antibes (FR); David Holmes, La Center, WA (US)

(72) Inventors: Mathew Smith, Antibes (FR); David Holmes, La Center, WA (US)

(21) Appl. No.: 14/849,935

(22) Filed: Sep. 10, 2015

Related U.S. Application Data
(60) Provisional application No. 62/049,942, filed on Sep. 12, 2014.

(51) Int. Cl. G06Q 20/20; G06Q 20/36; G06Q 20/40; G06Q 20/14

(52) U.S. Cl. CPC G06Q 20/202; G06Q 20/14; G06Q 20/3672; G06Q 20/405

(57) ABSTRACT

A point-of-sale (POS) product enhancement system for the creation of enhanced software features in products at the POS. The POS product enhancement system comprising at least one register and contactless POS terminal operated by a retailer at a retail location and a central server operated by a central server company at a remote location. The register is configured for identifying a product, indicating one or more enhancements available for the product, and receiving indication of a selected enhancement from the customer. The contactless read/write terminal is in communication with the register and configured for receiving a PEA (product creation authorization) token for the selected enhancement, validating the PEA token and executing the enhancement of the product via an RFID tag coupled to the product, generating an audit record of the enhancement of the product, and sending the audit record from the contactless POS terminal to the central server.

### CROSS-REFERENCE TO RELATED APPLICATION

This application claims the benefit of U.S. Provisional Application No. 62/049,942, filed 2015 Sep. 12, incorporated herein by reference.

### FIELD OF THE INVENTION

The present invention relates to the field of Point of Sale (POS) terminals with contactless or NFC (Near field Communication) or RFID (radio frequency identification) capabilities.

### BACKGROUND

Today many products that are being sold are tagged with a UHF (Ultra High Frequency) type tag that is used mainly for supply chain management, security and sometimes item scanning These have the advantage of a long read range but require large antenna or an expensive reader to read them. NFC compatible RFID tags compliant to the ISO 14443 standards are HF (High Frequency 13.56 MHz) and can be read by mobile phones, tablets, and the new generation of Point of Sale (POS) contactless read/write terminals. The latest generation of contactless credit and debit payment cards is also compatible with this standard. In addition, a new generation of toys is being sold that also embed NFC/RFID tags and conform to the same standard. These toys in turn can communicate with video game consoles such as Sony Playstation® and Microsoft XBox™ equipped with an NFC/RFID reader, to enhance game play. Additionally, many products today depend on embedded software to enable certain functions of the product, or indeed the whole product depends on software to be of any value to a consumer.

The nature of modern product design is that common hardware platforms are frequently used across product lines to minimize product costs through economies of scale. The differentiation of two similar products is often made by changing some of the superficial external parts or shell, and/or embedding different software or a different software configuration. The hardware shell simply changes the way the product looks. However, different software or software configuration changes the functionality of the product.

As more and more physical products contain software and interact with other digital products via software, the need to manage the configuration and software feature set as sold becomes increasingly important as a revenue driver for product manufacturers and retailers. Further, when a consumer is at the point of sale (POS) they are ready to make a purchase and at that point the transactional friction of purchasing additional features is reduced and hence can be a significant source of up-sale value for the retailer and manufacturer alike.

In general, retailers purchase their goods ahead of time, so they have items ‘in stock’. When the goods are delivered to the retailer, there is currently no way to modify the digital content of a product using an RFID tag attached to the product. This means that the digital features associated with the RFID tag and any software embedded in the product are fixed at the time of the sale transaction. There is currently no way to discover what a customer may wish to purchase in addition to the standard digital features of a product and modifying the RFID contents accordingly. This dynamic puts a lot of pressure on retailers to stock the right products with the right features and software configurations to meet consumer demand.

Since a retailer may sell multiple different RFID enabled products from multiple different product manufacturers or suppliers, there exists a need for a technical service to provide the infrastructure, transaction processing and logging and settlement to minimize intercompany connections and unnecessary repeated complexity.

Therefore a system is needed to allow the software features of a physical product to be securely activated, configured, and enhanced at the POS, that integrates a simple mechanism to read and activate digital features, and a generic device for the sales persons performing the configuration. Additionally the system needs to record transactions so as to report revenues to product manufacturers and suppliers, and update the system on a periodic basis.

### SUMMARY

Embodiments of a point-of-sale (POS) product enhancement system for the secure and controlled creation of enhanced software features in products at the point of sale (POS) are described herein. The exemplary POS product enhancement system comprises at least one register and contactless POS terminal operated by a retailer at a retail location and a central server operated by a central server company at a location remote from the retail location. The register is configured for identifying a product, indicating one or more enhancements available for the product, receiving indication of a selected enhancement from the customer, adding a price for the selected enhancement to a bill for the customer; and recording payment from the customer for the bill.

Either the register or a back officer server operated by the retailer is configured for generating a PEA (product enhancement authorization) token for the selected enhancement and transmitting the PEA token to the contactless POS terminal.

The contactless read/write terminal is in communication with the register and configured for receiving the PEA token for the selected enhancement, validating the PEA token, obtaining instructions for the selected enhancement, verifying that the selected enhancement can be executed, indicating readiness to enhance the product, detecting the product, executing the enhancement of the product via an RFID tag coupled to the product, generating an audit record of the enhancement of the product, and sending the audit record from the contactless POS terminal to the central server.

The central server is configured for requesting the audit record from the contactless POS terminal, receiving the audit record from the contactless POS terminal, generating an invoice of the enhancement for a retailer operating the register, generating an income statement for a manufacturer of the product, and updating a set of enhancement instructions stored on the contactless POS terminal.

Other embodiments of this aspect include corresponding computer systems, apparatus, and computer programs recorded on one or more computer storage devices, each configured to perform the actions of the methods.

### BRIEF DESCRIPTION OF THE DRAWINGS

The present invention will be described by way of exemplary embodiments, but not limitations, illustrated in the accompanying drawings in which like references denote similar elements, and in which:

The accompanying drawings, which are incorporated into and constitute a part of this specification, illustrate one or more embodiments of the invention and, together with the detailed description, serve to explain the principles and implementations of the invention.

FIG. 1 is a block diagram of retail location components of a POS product software enhancement system for enhancing the software of products at the point of sale (POS).

FIG. 2 is a block diagram of components of a contactless POS read/write terminal, part of the product software enhancement system.

FIG. 3 is a block diagram of a POS product software enhancement system for enhancing the software of products at the point of sale (POS).

FIGS. 4A-4C present a flow chart for a contactless POS product enhancement method using the exemplary POS product enhancement system.

### DETAILED DESCRIPTION

Before beginning a detailed description of the subject invention, mention of the following is in order. When appropriate, like reference materials and characters are used to designate identical, corresponding, or similar components in different figures. The figures associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Use of directional terms such as “upper,” “lower,” “above,” “below”, “in front of,” “behind,” etc. are intended to describe the positions and/or orientations of various components of the invention relative to one another as shown in the various Figures and are not intended to impose limitations on any position and/or orientation of any embodiment of the invention relative to any reference point external to the reference.

Those skilled in the art will recognize that numerous modifications and changes may be made to the exemplary embodiment(s) without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the exemplary embodiment(s) is essential. Other embodiments are possible, their specific designs depending upon the particular application. As such, the scope of the invention should not be limited by the particular embodiments herein described but should be defined only by the appended claims and equivalents thereof

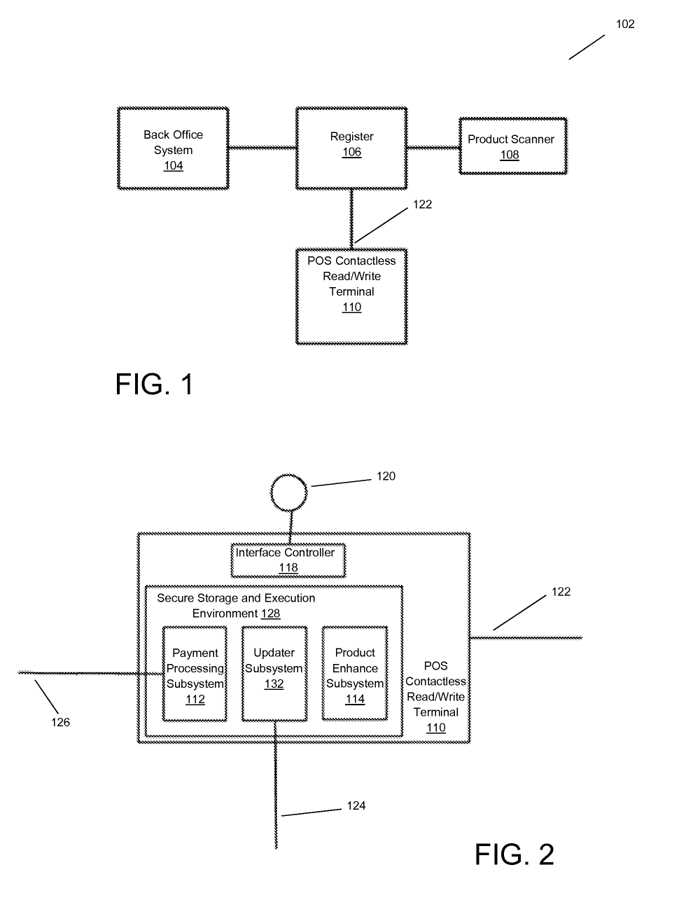

FIGS. 1-3 show an exemplary embodiment of a POS product enhancement system 100 and its components for the secure and controlled creation of enhanced software features in products at the point of sale (POS). The exemplary POS product enhancement system 100 has components for the control, recording and transaction handling and settlement mechanisms for individual transactions between customers, retailers, product manufacturers and for the management of exemplary POS product enhancement system 100 as a whole.

FIG. 1 is a block diagram of retail location components 102 of the exemplary POS product enhancement system 100. At the retail location, the exemplary POS product enhancement system 100 has at least one register 106 and is typically connected to a back office system 104 for tracking sales and inventory. The register 106 is a device configured for recording transactions at the point-of-sale. The register 106 is often colloquially called a “cash” register, even if it primarily handles cashless transactions. The register 106 is typically connected to a product scanner 108 for identifying products to be purchased, such as a barcode scanner or QR code scanner. The register 106 may have other inputs that can be used for identifying products, such as manually entering a product code, such an SKU, via a keyboard. The retail location also has a contactless POS read/write terminal 110 connected to the register 106 with a local connection 122 that may be wireline or wireless. The contactless POS read/write terminal 110 may be used for entering payment information. In the exemplary POS product enhancement system 100, the contactless POS read/write terminal 110 is also used to enhance the software of products. Enhancing the software of products may include upgrading the software to a new version; adding additional software modules; or enabling features previously disabled.

FIG. 2 is a block diagram of components of the contactless POS read/write terminal 110. The contactless POS read/write terminal 110 of the exemplary embodiment has an antenna 120 and an interface controller 118 configured for short range wireless electronic communication with NFC compatible RFID tags compliant to the ISO 14443 standards, though in other embodiments, another standard may be used. The contactless POS read/write terminal 110 has several software modules in a secure storage and execution environment 128, including, a payment processing subsystem 112, a product enhancement subsystem 114, and an updater subsystem 132.

The product enhancement subsystem 114 is configured for storing and controlling its own cryptographic keys and for executing enhancements on RFID tags. The product enhancement subsystem 114 has a Product Enhancement Definition Table, which is a database that contains instructions and procedures for enhancements available to it, organized by predefined Product Type IDs (typically a SKU) and Product Enhancement Reference IDs. The Product Enhancement Definition Table includes instructions for executing an enhancement or configuring the feature or features associated with the Product Type ID.

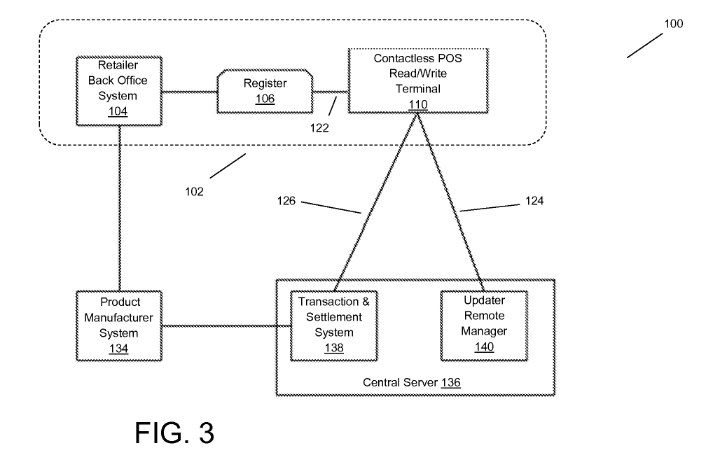

FIG. 3 is a block diagram of the exemplary POS product enhancement system 100, including both retail location components 102 and components typically in locations other than the retail location. In addition to the retail location components 102, the exemplary POS product enhancement system 100 has a central server 136. The central server 136 has a first network connection 124 and a second network connection 126 to the contactless POS read/write terminal 110. The central server 136 is operated by an entity referred to herein as the “Central Server Operating Company.” The Central Server Operating Company is typically a different entity than the entity that operates the retail location components 102. For simplicity, only one set of retail location components 102 are shown, but typically, the Central Server Operating Company will serve many different retail companies, each with different retail locations and some companies with multiple retail locations, so the central server 136 will typically serve multiple retail locations, each have a set of retail location components 102. In some embodiments the central server 136 is a single physical device, but in other embodiments, it is comprised of several physical devices that may not even be at the same location, but are interconnected and operate in a coordinated fashion.

The central server 136 has software components that it stores and executes, including a transaction & settlement system 138, and an updater remote manager 140. The transaction & settlement system 138 handles the accounting of transactions relating to product enhancements. The transaction & settlement system 138 has a network connection to one or more product manufacturer systems 134 to facilitate exchange of information relating to sales of product enhancements. The updater remote manager 140 is configured to manage the provisioning of contactless POS read/write terminals 110 at various retail locations, providing new enhancements and otherwise ensuring the contactless POS read/write terminals 110 have the correct and current enhancement data and installation instructions.

For each retail location, the updater remote manager 140 has access to the contactless POS read/write terminal 110 via a first network connection 124. The first network connection 124 may need to traverse firewalls of the retailer and other network providers involved. One of the main updates involved is the addition and removal of information regarding availability of enhancement(s) per product type. Another update is the addition and removal of product enhancement instructions in the Product Enhancement Definition Table.

A Product Enhancement Definition Table in a contactless POS read/write terminal 110 needs updating when a new product enhancement is defined and available in the retail context, when a product enhancement needs to be changed for any reason, or when the product enhancement needs to be removed from the table. The updater remote manager 140 performs this role using the first network connection 124 and encrypts all traffic and payload to ensure that the product enhancement instructions remain secret at all times.

### POS Product Enhancement—Method of Operation

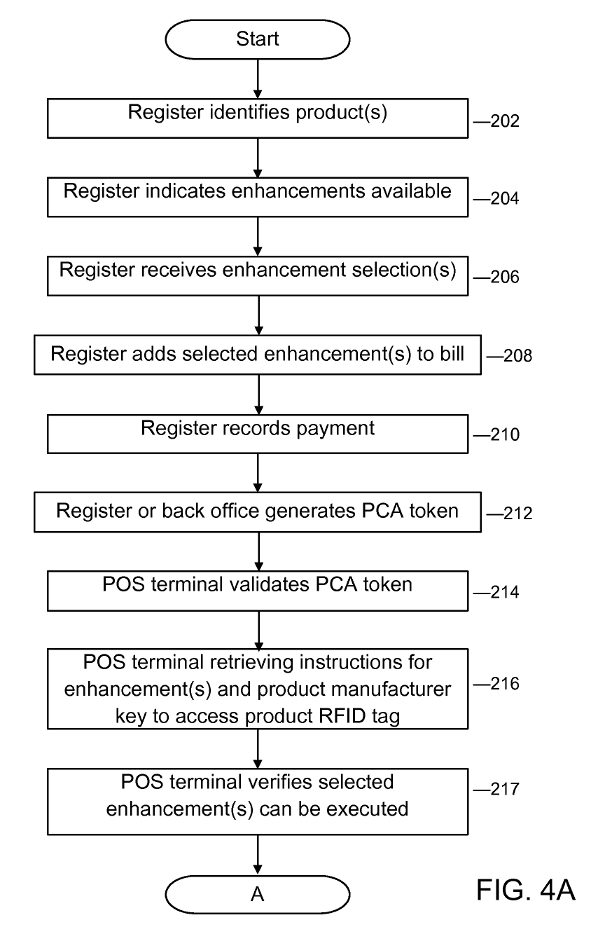

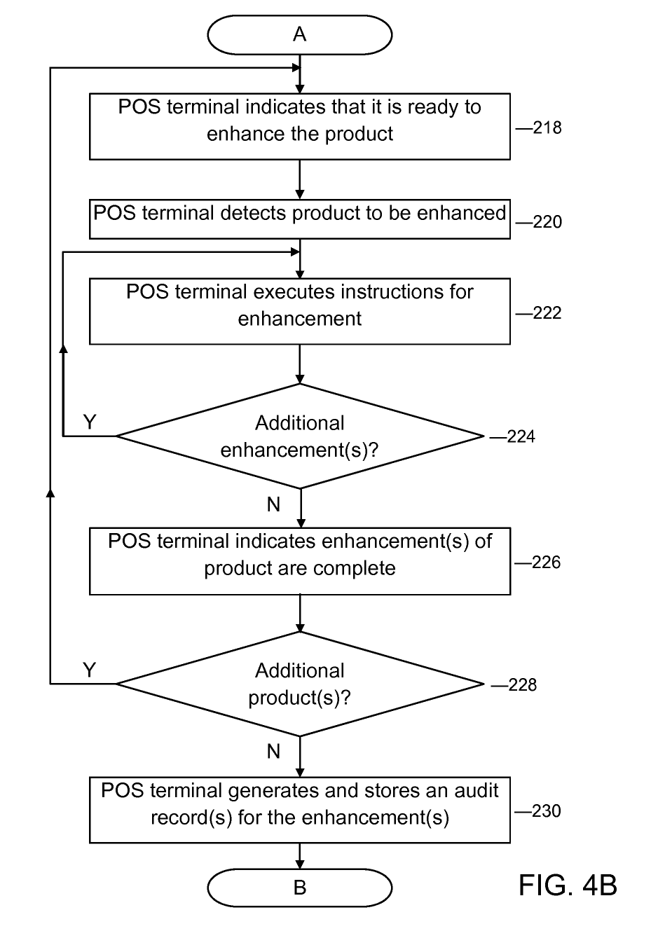

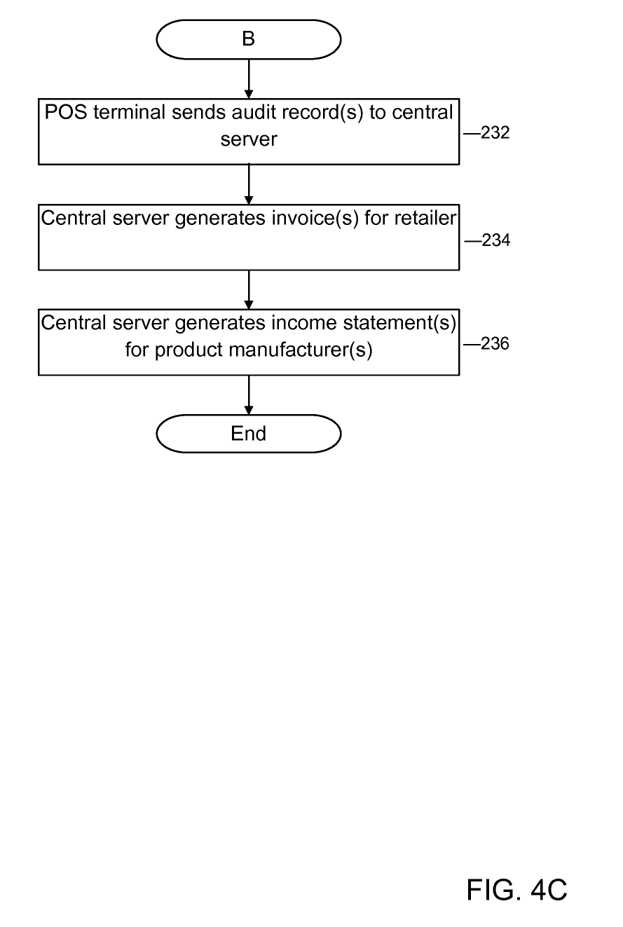

FIGS. 4A-4C present a flow chart for a contactless POS product enhancement method 200 using the exemplary POS product enhancement system 100. This method and system could be used when, for example, a customer wants to buy a product at a retail store and the product contains a microprocessor and a memory in which data and software are stored. The product is designed such that its functions depend on the stored software and data. The product may interact with other products either already owned by the customer, owned by some third party (like a set-top box or gaming console) or that the customer will buy in the future. The method begins when the customer presents a package containing the product at the Point of Sale (POS). The register 106 identifies the product (step 202). This may be accomplished by the cashier scanning the product with the product scanner 108 or some other type of scanner or manually entering a product identification code into the register 106. The register 106 indicates that the package contains a product (or products) that may be enhanced (step 204). Based on this information, the cashier can then offer the customer enhancements such as additional or alternative features and functions for the product.

The register 106 then receives enhancement selection(s) (step 206). The selection of enhancements can be performed by a customer or sales assistant using barcodes (or other codes such as QR codes) on a paper or electronic form to select certain features which are then available. The form is scanned with the product scanner 108 at the POS when the product is scanned. Alternatively, the register 106 may present the enhancements available for the product on a screen and the customer or the cashier selects the enhancements via some data entry, such as a touch screen or keyboard.

If the customer chooses to buy the additional or alternative features and functions for the product, then the register 106 creates the sales item based on predefined Stock Keeping Units (SKUs) at that POS and adds them to the customer bill. The enhancements chosen by the customer are added to the bill by the register 106 (step 208). The customer pays as normal for a POS transaction and the register 106 records the payment (step 210).

Once the payment is completed, the register 106 (or the back office system 104 for the retailer) then generates an authorization token called Product Enhacement Approval token (PEA token) (step 212). The PEA token is sent to the product enhancement subsystem 114 in the contactless POS read/write terminal 110. In the exemplary embodiment, any product enhancement(s) must be paid for prior to the PEA token being generated. However, in other embodiments, the PEA token may be generated before payment has been completed. This PEA token is a cryptographic certificate containing a signed enhancement instruction, based on the retailer's cryptographic keys, that is a one-time certification to authorize the enhancement transaction. The format of the instruction is based on predefined SKU's that are installed in the contactless POS read/write terminal 110 and updated periodically.

The PEA token is a cryptographically signed data package such as defined in PKCS#1 or Digital Signature Standard (DSS)/Digital Signature Algorithm (DSA) Federal Information Processing Standard (FIPS-PUB-186). The PEA token contains instructions regarding the product enhancements to be performed, and serves as an authentication, authorization, audit and nonrepudiation mechanism.

The PEA token contains the information regarding the product enhancements to be performed. This includes but is not limited to the Stock Keeping Unit of the package (SKU or other identifier for the package), the list of Product Type References, the set of Product Enhancement IDs to apply to each product type. An example of the data set inside the PEA token is as follows (but not limited to):
PEA Reference (a unique identifier for the PEA)
Date/Time stamp for the PEA creation
Package SKU (a unique identifier for the package in the reader)
Payment Reference (unique identifier linking to the payment information for the product enhancements)
A set of (one for each product enhancement):
   A Product Type Reference (a unique reference identifying the particular type of product e.g. a particular toy or figurine);
   A Product Item Unique Identifier, in the case where there are multiple items of the same Product Type Reference (this is optional and if there is only one instance of the product type in the package, it is not needed, though may be included for completeness); and
   A Product Enhancement Reference (a unique reference identifying the actual product enhancement transaction)

Additional data may be included in the PEA token and can include but are not limited to, Retailer Reference, Store Reference, Register Details, Cashier Reference, and other transactional information.

The product enhancement subsystem 114 of the contactless POS read/write terminal 110 then validates the PEA token using a private key (step 214). Once validated, the product enhancement subsystem 114 obtains a series of instructions to execute the enhancement requested in the PEA token and typically a product manufacturer key, a separate cryptographic key issued by the product manufacturer that permits write access to the product RFID tag (step 216).

The product enhancement subsystem 114 obtains the instructions for the requested enhancement(s) from the Product Enhancement Definition Table, which is stored in the secure storage and execution environment 128 inside the contactless POS read/write terminal 110. The Product Enhancements Definition Table stores the specific detailed instructions for each product type that can be enhanced or upgraded. The instructions may be in the form of a script definition that is parsed inside the contactless POS read/write terminal 110, or in the form of stored Application Protocol Data Unit (APDU) templates, other forms of instructions may be used in other embodiments. APDUs are the standard method of communicating with ISO 14443 standard RFID tags. The product manufacturer key may be needed to cryptographically sign the APDUs.

The product manufacturer key is stored in a separate part of the secure storage and execution environment 128 inside the contactless POS read/write terminal 110. The product manufacturer key is usually needed because most product manufacturers protect the RFID tag in their products from unauthorized modification with the product manufacturer key. Typically, the product manufacturer key is used to generate the APDUs. The specific mechanism of cryptographic protection may vary from one product manufacturer to another, but the specific detailed instructions for each product type obtained from the Product Enhancement Definition Table will specify the process of unlocking the RFID tag write protection.

In some embodiments, the ADPUs are generated at the central server 136 and then sent to the contactless POS read/write terminal 110 in real time following a request from the product enhancement subsystem 114. A further level of encryption would protect this communication.

The product enhancement subsystem 114, according to the instructions obtained from the Product Enhancements Definition Table verifies that the selected product enhancement for a product is available and can be performed (step 217).

The contactless POS read/write terminal 110 indicates that it is ready to execute the enhancement (step 218) by audio signals, visual signals or other type of signals. The product enhancement subsystem 114 attempts to complete the enhancement(s) without further logical or data input from the cashier or customer following the receipt of the PEA token. However, if the product(s) to be enhanced are not within range of the contactless POS read/write terminal 110, then it waits until the cashier or the customer places the product against the contactless POS read/write terminal 110 such that the RFID tag attached to the product can be read and written to by the terminal. The contactless POS read/write terminal 110 then detects the product to be enhanced (step 220) and identifies the product type by reading the product's RFID tag and verifying that it is suitable for the enhancement.

The product enhancement subsystem 114 of the contactless POS read/write terminal 110 then executes the instructions for enhancement (step 222). The product enhancement subsystem 114 prepares the product enhancement as an execution job for the contactless POS read/write terminal 110. The product enhancement subsystem 114 performs the execution job preparing the individual APDUs for a product enhancement and then applying them to the product. Alternatively, the APDUs can be generated on demand during the product enhancement process. In some embodiments, more than one product may be enhanced or upgraded in a single step. This may be achieved by a parallel multithreaded implementation of the product enhancement algorithm for each product item enhanced, either using prebuilt APDUs or building them on demand.

The product enhancement subsystem 114 then determines if additional enhancements for the product item need to be executed (step 224). If so, then the product enhancement subsystem 114 repeats step 222.

After all enhancements indicated in the PEA token have been executed, the contactless POS read/write terminal 110 then indicates the enhancement(s) of the product are complete (step 226). The cashier or customer can then remove the package from the field of the contactless POS read/write terminal 110. The contactless POS read/write terminal 110 determines if there were additional products to be enhanced (step 228) as indicated in the PEA token(s). If so, then the contactless POS read/write terminal 110 repeats steps 218-226.

The product enhancement subsystem 114 then generates an audit

record for the enhancement(s) and stores it in a file inside the secure storage and execution environment 128 of the contactless POS read/write terminal 110 (step 230). The Audit Record will contain the information from the PEA token plus the Unique Identifier (UID) of the products enhanced during the transaction plus date and time of the transaction plus any other additional data regarding the transaction that may be required by the central server company or the retailer.

The contactless POS read/write terminal 110 is connected via a network connection to a central server 136. The central server 136 periodically polls the contactless POS read/write terminal 110 and in response, the contactless POS read/write terminal 110 initiates a transfer of the audit record file(s) to the central server 136 (step 232). In other embodiments, the contactless POS read/write terminal 110 initiates the transmission of the file itself. All communications between the central server 136 and the contactless POS read/write terminal 110 are encrypted.

When the central server 136 receives a product enhancement transaction audit record from a contactless POS read/write terminal 110 it processes the record into its own database. The record then forms part of a settlement process whereby the central server 136 uses commercial contract data regarding pricing and retailer and manufacturer data to generate invoices for the retailers (step 234) and generate income statements for the product manufacturer(s) (step 236). Since the Central Server Operating Company may have entered into multiple agreements between multiple product manufacturers and multiple retailers, it can generate an invoice for each retailer for all the product manufacturers concerned. Payments from the retailers are made to the Central Server Operating Company. Individual product manufacturer income statements then are used by the Central Server Operating Company to pay the individual Manufacturers for the product enhancements performed on their products. Other embodiments may have different invoice, statement and revenue flows.

### RFID Configurations—Overview

The exemplary POS product enhancement system 100 and alternative embodiments thereof, may interact with different configurations of RFID tags, including where the RFID tag is:
1. A functioning part of the product e.g. a toy for video game character control;
2. An identifier for referencing the specific individual product item with a third party product enhancement server; and
3. Connected directly to a microcontroller in the product.

The RFID tag may be attached to the product in a number of different ways. It can be stuck on the product or product packaging using self-adhesive stickers or embedded in a suitable substrate such as a thin layer of polyurethane that allows for the tag to be read without interference.

### First RFID Configuration—RFID Tag as a Functioning Part of the Product

In configurations where the RFID tag is an intrinsic part of the product, the RFID tag is a core feature of the product and the POS based enhancement is in the form of additional data written to the data areas of the RFID tag. An example of this is a toy/figurine used as a token for a virtual character for play within a video game on a game console (such as Sony Playstation, Microsoft XBox, or Nintendo Wii) in combination with an RFID reader attached to the console. When the toy is purchased, the customer is offered the chance to add game items to the toy at the point of sale such that they are available with the virtual character or enhance the character when it is used in the console game (e.g. a sword or potion or additional powers). The data enabling the additional game item and/or features is written into the RFID tag in the base of the toy at the time of sale by the exemplary POS product enhancement system 100 or an embodiment similar thereto.

### Second RFID Configuration—RFID Tag Only Identifies Product

In another RFID tag configuration, the RFID tag is not a part of the primary functions of the product, but the RFID tag serves primarily to uniquely identify the product to which it is attached. Enhancement of the product is triggered by reading the RFID tag and the actual enhancement is executed via another, separate channel. This channel may be in the form of a wired or wireless connection with the product. The enhancement is triggered by the RFID encoding the unique identity and model of the product and further generating a cryptographic approval token (e.g. in PCKS#1, DSA/DSS format) which is forwarded to a separate product enhancement server. This separate product enhancement server receives such enhancement instructions and processes the enhancement by connecting to the product and carrying out the enhancement either immediately or waiting until a connection with the product is established.

An example of this is when the product is powered up once the customer returns to their home and connects via a network such as the internet, the product automatically connects to the separate Enhancement Server and receives the enhancements in the form of a software download from the enhancement server, based on the Enhancement Authorization issued by the retailer at the POS.

### Third RFID Configuration—RFID Tag Attached to Microcontroller

In other embodiments there is an electronic connection between the RFID tag attached to a microcontroller inside the product itself. In this configuration a ‘wired connection’ is made between the circuit board containing the product's microprocessor and the RFID chip. The RFID chip pinout allows for a connection over a standard interface such as I2C (‘I squared C’). In this configuration the RFID is connected by a physical interface to the memory storage and / or microprocessor of the product, the RFID product enhancement transaction performed by the exemplary POS product enhancement system 100 can write enhancement data into the RFID tag. When the product is powered up for the first time (which may be in the retail store or in the home of the customer or other location) a configuration process occurs where the software controlling the product executes a onetime enhancement.

The process runs in the microcontroller of the product and reads the contents of the RFID tag via the electronic interface. The enhancement/configuration data stored in the RFID tag by the contactless POS read/write terminal 110 is then read into the storage and working memory of the microcontroller of the product. The configuration process then uses this data, including any updates in the data that may have been added by the contactless POS read/write terminal 110, to execute the product configuration.

The configuration proceeds according to the data in the tag. This configuration can be reversible or not. The configuration can be in the form of a configuration file in the product or it could be different binary software program images stored in the memory of the product, where the correct image is loaded according to the data in the RFID tag and the product then starts with the enhancement configuration purchased by the customer.

In most RFID configurations and embodiments of contactless product enhancement systems, authorization for the enhancement is provided to a reader in the form of an encrypted token or certificate that authorizes the RFID writer to write the enhancement data or instructions to the product. This token is signed by the retailer of the product and is used to invoice that retailer on behalf of the product manufacturer.

### Additional Embodiments of Contactless Product Enhancement Systems

In additional embodiments of product enhancement systems, the contactless POS read/write terminal 110 may be replaced by an NFC enabled Mobile Phone or Tablet or other mobile device. The principle of updating an RFID tag embedded inside a product is similar; however the device performing the product enhancement action is a personal device rather than retail infrastructure. In this way the product enhancement process can be performed by the customer using their own phone in a location that is not the retail store. For this purpose a suitable mobile application that contains a product enhancement subsystem, together with all its relevant components will be deployed that will communicate securely with the Central server.

The consumer will need an account with the Central Server and the ability to pay for product enhancements. This will then allow a consumer to perform their own product enhancements on their own products.

What is claimed is:

1. A method for a POS (point-of-sale) contactless product enhancement, comprising the steps of:
identifying a product with a register operated by a retailer at a retail location;
indicating, with the register, one or more enhancements available for the product;
receiving, with the register, indication of a selected enhancement from a customer;
adding, with the register, a price for the selected enhancement to a bill for the customer;
recording, with the register, payment from the customer for the bill;
generating a product creation authorization token (a PEA token) for the selected enhancement;
validating, with a contactless POS terminal, the PEA token;
obtaining, with the contactless POS terminal, instructions for the selected enhancement;
verifying, with the contactless POS terminal, that the selected enhancement can be executed;
indicating, with the contactless POS terminal, readiness to enhance the product;
detecting, with the contactless POS terminal, the product;
executing, with the contactless POS terminal, the enhancement of the product;
generating, with the contactless POS terminal, an audit record of the enhancement of the product;
sending the audit record from the contactless POS terminal to a central server;
generating, with the central server, an invoice of the enhancement for the retailer; and
generating, with the central server, an income statement for a manufacturer of the product.

2. A method for a POS (point-of-sale) contactless product enhancement, comprising the steps of:
identifying, with a register, a product and a product type associated with the product;
indicating, with the register, one or more enhancements available for the product type;
receiving, with the register, indication of a selected enhancement from a customer;
generating a product creation authorization token (a PEA token) for the selected enhancement;
validating, with a contactless POS terminal, the PEA token;
executing, with the contactless POS terminal, the enhancement of the product via an RFID tag coupled to the product;
generating, with the contactless POS terminal, an audit record of the enhancement of the product; and
sending the audit record from the contactless POS terminal to a central server.

3. The method of claim 2, further comprising the step(s) of:
executing any additional enhancements of the product, if PEA tokens for the additional enhancements for the product have been received by the contactless POS terminal.

4. The method of claim 2, further comprising the step(s) of:
executing any additional enhancements for one or more additional products, if any additonal PEA tokens for additional enhancements for the one or more additional products have been received by the contactless POS terminal.

5. The method of claim 2,
wherein the generating of the PEA token is performed by a back office server.

6. The method of claim 2,
wherein the generating of the PEA token is performed by the register.

7. The method of claim 2, further comprising the step(s) of:
adding, with the register, a price for the selected enhancement to a bill for the customer; and
recording, with the register, payment from the customer for the bill.

8. The method of claim 2, further comprising the step(s) of:
retrieving, with the contactless POS terminal, instructions for the selected enhancement;
verifying, with the contactless POS terminal, that the selected enhancement can be executed;
indicating, with the contactless POS terminal, readiness to enhance the product; and
detecting, with the contactless POS terminal, the product.

9. The method of claim 2, further comprising the step(s) of:
retrieving, with the contactless POS terminal, instructions for the selected enhancement;
retrieving, with the contactless POS terminal, a product manufacture key for the product type;
generating, with the contactless POS terminal, an APDU (Application Protocol Data Unit) using the instructions for the selected enhancement and using the product manufacturer key; and
transmitting, with the contactless POS terminal, the APDU to the product.

10. The method of claim 2, further comprising the step(s) of:
sending, with the contactless POS terminal, a request to the central server for an APDU (Application Protocol Data Unit) generated using the instructions for the selected enhancement and using a product manufacturer key;
receiving, with the contactless POS terminal, the APDU; and
transmitting, with the contactless POS terminal, the APDU to the product.

11. The method of claim 2, further comprising the step(s) of:
generating, with the central server, an invoice of the enhancement for a retailer operating the register; and
generating, with the central server, an income statement for a manufacturer of the product.

12. The method of claim 2, further comprising the step(s) of:
updating, using the central server, a set of enhancement instructions stored on the contactless POS terminal.

13. A point-of-sale product enhancement system comprising:
a register configured for:
identifying a product and a product type associated with the product,
indicating one or more enhancements available for the product, and
receiving indication of a selected enhancement from a customer; and
a contactless POS terminal in communication with the register and configured for:
receiving a product creation authorization token (a PEA token) for the selected enhancement,
validating the PEA token,
executing the enhancement of the product via an RFID tag coupled to the product,
generating an audit record of the enhancement of the product, and
sending the audit record from the contactless POS terminal.

14. The system of claim 13,
wherein the register is further configured for:
generating the PEA token for the selected enhancement, and
transmitting the PEA token to the contactless POS terminal.

15. The system of claim 13, further comprising:
a back office server configured for:
generating the PEA token for the selected enhancement, and
transmitting the PEA token to the contactless POS terminal.

16. The system of claim 13,
wherein the register is further configured for:
adding a price for the selected enhancement to a bill for the customer; and
recording payment from the customer for the bill.

17. The system of claim 13,
wherein the contactless POS terminal is further configured for:
obtaining instructions for the selected enhancement,
verifying that the selected enhancement can be executed,
indicating readiness to enhance the product, and
detecting the product.

18. The system of claim 13,
wherein the contactless POS terminal is further configured for:
retrieving instructions for the selected enhancement;
retrieving a product manufacture key for the product type;
generating an APDU (Application Protocol Data Unit) using the instructions for the selected enhancement and using the product manufacturer key; and
transmitting the APDU to the product.

19. The system of claim 13,
wherein the contactless POS terminal is further configured for:
sending a request for an APDU (Application Protocol Data Unit) generated using the instructions for the selected enhancement and using a product manufacturer key;
receiving the APDU; and
transmitting the APDU to the product.

20. The system of claim 13, further comprising:
a central server configured for:
requesting the audit record from the contactless POS terminal,
receiving the audit record from the contactless POS terminal,
generating an invoice of the enhancement for a retailer operating the register, and
generating an income statement for a manufacturer of the product.

21. The system of claim 20,
the central server further configured for:
updating a set of enhancement instructions stored on the contactless POS terminal.
